(19) United States
(12) Patent Application Publication
(10) Pub. No.: US 2026/0367812 A1
(43) Pub. Date: Nov. 19, 2026

(54) System and Method For Processing Data, Device, Medium, and Program Product

(71) Applicant: IEIT SYSTEMS CO., LTD., Jinan (CN)

(72) Inventors: Xiaolin CHEN, Jinan (CN); Yaqiang ZHANG, Jinan (CN); Yaqian ZHAO, Jinan (CN); Hongzhi SHI, Jinan (CN); Xiao LI, Jinan (CN); Fei GAO, Jinan (CN); Guangyuan XU, Jinan (CN)

(73) Assignee: IEIT SYSTEMS CO., LTD., Jinan (CN)

(21) Appl. No.: 19/678,857

(22) Filed: May 15, 2026

(30) Foreign Application Priority Data
May 16, 2025 (CN) 202510630314.8

(51) Int. Cl. G06F 3/06

(52) U.S. Cl. CPC G06F 3/0629; G06F 3/0604; G06F 3/0683

(57) ABSTRACT

Provided are a system and a method for processing data, device, medium, and program product in the field of computer technology. In the present disclosure, each accelerator card among a plurality of accelerator cards is directly connected to a plurality of memory devices through a management device, and the management device collects actual operation information of each accelerator card among the plurality of accelerator cards, so as to allocate memory space to each accelerator card on demand according to the actual operation information of the accelerator cards.

### CROSS-REFERENCE TO RELATED APPLICATION

This application claims priority to Chinese Patent Application No. 202510630314.8, filed to the China National Intellectual Property Administration on May 16, 2025 and entitled “Data Processing System, Method, Device, Medium, and Program Product”, the disclosure of which is hereby incorporated by reference in its entirety.

### TECHNICAL FIELD

The present disclosure relates to the field of computer technology, and particularly to a system and a method for processing data, device, medium, and program product.

### BACKGROUND

Currently, the demand for memory capacity of accelerator cards is increasing. Generally, host memory can be used as extended memory for the accelerator cards to achieve memory expansion for the accelerator cards, but the host memory capacity is limited. To provide more memory space for the accelerator cards, the host extended memory can be provided for use by the accelerator cards, but the host needs to perform memory allocation for each accelerator card. If a plurality of accelerator cards simultaneously request memory from the host, contention for resources such as bandwidth is likely to occur, resulting in increased data transmission latency and affecting overall performance.

Therefore, how to expand memory for the accelerator cards without affecting system operation performance is a problem that those skilled in the art need to solve.

### SUMMARY

In view of this, an object of the present disclosure is to provide a system and method for processing data, device, medium, and program product, so as to expand memory for accelerator cards without affecting system operation performance.

In a first aspect, the present disclosure provides a system for processing data, including: a management device, a plurality of accelerator cards, and a plurality of memory devices, wherein each accelerator card among the plurality of accelerator cards is connected to the plurality of memory devices through the management device; the management device is configured to: collect actual operation information of each accelerator card among the plurality of accelerator cards; the management device is further configured to: for any target accelerator card among the plurality of accelerator cards, predict a memory demand amount of the target accelerator card according to the actual operation information of the target accelerator card, and select at least one memory type, and determine a memory allocation result of the target accelerator card according to the memory demand amount and the at least one memory type; and the target accelerator card is configured to: update a memory configuration according to the memory allocation result.

In a second aspect, the present disclosure provides a method for processing data, applied to a management device, wherein the management device is connected to a plurality of accelerator cards and a plurality of memory devices, including: collecting actual operation information of each accelerator card among the plurality of accelerator cards; for any target accelerator card among the plurality of accelerator cards, predicting a memory demand amount of the target accelerator card according to the actual operation information of the target accelerator card, and selecting at least one memory type; and determining a memory allocation result of the target accelerator card according to the memory demand amount and the at least one memory type, so that the target accelerator card updates a memory configuration according to the memory allocation result.

In a third aspect, the present disclosure provides an electronic device, including: a memory, configured to store a computer program; a processor, configured to execute the computer program, so as to implement the method for processing data disclosed above.

In a fourth aspect, the present disclosure provides a non-volatile storage medium, configured to store a computer program, wherein the computer program, when executed by a processor, implements the method for processing data disclosed above.

In a fifth aspect, the present disclosure provides a computer program product, including a computer program/instruction, wherein the computer program/instruction, when executed by a processor, implements the steps of the method for processing data disclosed above.

It can be known from the above solutions that the present disclosure provides a system for processing data, including: a management device, a plurality of accelerator cards, and a plurality of memory devices, wherein each accelerator card among the plurality of accelerator cards are connected to the plurality of memory devices through the management device; the management device is configured to: collect actual operation information of each accelerator card among the plurality of accelerator cards; the management device is further configured to: for any target accelerator card among the plurality of accelerator cards, predict a memory demand amount of the target accelerator card according to the actual operation information of the target accelerator card, and select at least one memory type, and determine a memory allocation result of the target accelerator card according to the memory demand amount and the at least one memory type; and the target accelerator card is configured to: update a memory configuration according to the memory allocation result.

It can be seen that the beneficial effects of the present disclosure are: each accelerator card among the plurality of accelerator cards is directly connected to the plurality of memory devices through the management device, and the management device collects the actual operation information of each accelerator card among the plurality of accelerator cards, so as to allocate memory space to each accelerator card on demand according to the actual operation information of the accelerator cards. That is: each memory device among the plurality of memory devices is not perceived by the host, the plurality of memory devices serve directly as extended memory for each accelerator card, thus it is unnecessary for the host to perform memory allocation for each accelerator card, thereby avoiding the situation of contention for resources such as bandwidth that is likely to occur when multiple accelerator cards simultaneously request memory, making data transmission latency less likely to occur, and achieving the purpose of expanding memory for the accelerator cards without affecting system operation performance.

Correspondingly, a method for processing data, device, medium, and program product provided by the present disclosure also have the above technical effects.

### BRIEF DESCRIPTION OF THE DRAWINGS

To more clearly illustrate the technical solutions of the embodiments of the present disclosure or the related art, a brief description will be given below to the drawings required to be used in the description of the embodiments or the related art. It is apparent that the drawings described below are merely the embodiments of the present disclosure. For those of ordinary skill in the art, other drawings may also be obtained according to these drawings without making creative labor.

FIG. 1 is a schematic diagram of a system for processing data disclosed by the present disclosure.

FIG. 2 is a flowchart of a method for processing data disclosed by the present disclosure.

FIG. 3 is a schematic diagram of another system for processing data disclosed by the present disclosure.

FIG. 4 is a schematic diagram of a system logic corresponding to FIG. 3 disclosed by the present disclosure.

FIG. 5 is a schematic diagram of an electronic device disclosed by the present disclosure.

FIG. 6 is a structural diagram of a server provided by the present disclosure.

FIG. 7 is a structural diagram of a terminal provided by the present disclosure.

### DETAILED DESCRIPTION OF THE EMBODIMENTS

The technical solutions in the embodiments of the present disclosure will be clearly and completely described below in conjunction with the drawings in the embodiments of the present disclosure. It is apparent that the described embodiments are merely a part, rather than all, of the embodiments of the present disclosure. Based on the embodiments in the present disclosure, all other examples obtained by those of ordinary skill in the art without making creative efforts shall fall within the scope of protection of the present disclosure.

Currently, to provide more memory space for the accelerator cards, the host extended memory can be provided for use by the accelerator cards, but the host needs to perform memory allocation for each accelerator card. If a plurality of accelerator cards simultaneously request memory from the host, contention for resources such as bandwidth is likely to occur, resulting in increased data transmission latency and affecting overall performance. To this end, the present disclosure provides a solution for processing data, enabling each memory device not to be perceived by the host. These memory devices serve directly as extended memory for each accelerator card, thus it is unnecessary for the host to perform memory allocation for each accelerator card, thereby avoiding the situation of contention for resources such as bandwidth that is likely to occur when multiple accelerator cards simultaneously request memory, making data transmission latency less likely to occur, and achieving the purpose of expanding memory for the accelerator cards without affecting system operation performance.

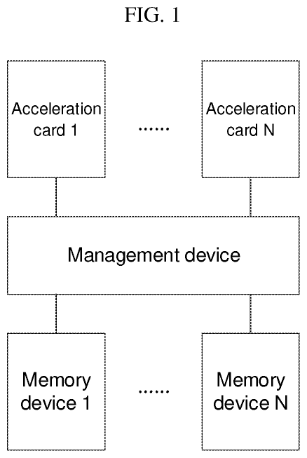

Referring to FIG. 1, embodiments of the present disclosure disclose a system for processing data, including: a management device, a plurality of accelerator cards: accelerator card 1 to accelerator card N, and a plurality of memory devices: memory device 1 to memory device N, wherein each accelerator card among the plurality of accelerator cards is connected to the plurality of memory devices through the management device.

The management device is configured to: collect actual operation information of each accelerator card among the plurality of accelerator cards. The management device is further configured to: for any target accelerator card among the plurality of accelerator cards, predict a memory demand amount of the target accelerator card according to the actual operation information of the target accelerator card, select at least one memory type, and determine a memory allocation result of the target accelerator card according to the memory demand amount and the at least one memory type; the target accelerator card is configured to: update a memory configuration according to the memory allocation result.

It should be noted that each memory device provides the same or different types of memory resources, and furthermore, one memory device may provide only Dynamic Random Access Memory (DRAM) resources or Solid State Drives (SSD) resources, or may provide both the DRAM resources and the SSD resources simultaneously. It can be seen that the memory type may be a DRAM resource type, an SSD resource type, etc.

The memory allocation result may record: which part of memory address of which memory device is allocated to the target accelerator device, what memory type this part of memory address belongs to, etc. Specifically, the memory allocation result may include: identification information of the memory device allocated to the target accelerator card, a device port, a port of the management device connected to the device port, a corresponding address segment, a memory type of the address segment, etc. Therefore, in an implementation, the management device is configured to: determine, according to the memory allocation result, one or more identification information of one or more memory devices among the plurality of memory devices allocated to the target accelerator card; record a mapping relationship between a port of each identification information (i.e., a port of the management device connected to a memory device port) of the one or more identification information and a port of the target accelerator card (i.e., a port of the management device connected to a target accelerator card port) in a routing table.

Correspondingly, the target accelerator card is configured to: determine, according to the memory allocation result, one or more the identification information and one or more address segments of the one or more memory devices among the plurality of memory devices allocated to the target accelerator card; record the one or more identification information and the one or more address segments in a memory mapping table. The memory mapping table is a table in the accelerator card recording the accelerator card available memory addresses, and each accelerator card is provided with a memory mapping table.

In this embodiment, the management device can collect the actual operation information of each accelerator card, so as to perceive the actual usage situation of each accelerator card in real time, such as: current memory occupation information of the accelerator card (which may include memory usage rate, memory occupation amount size, etc.), current task queue information of the accelerator card to be processed (which may include an uncompleted task type and a number of uncompleted tasks), etc. Therefore, in an implementation, the management device is configured to: collect the memory occupation information, the task queue information, and throughput in each accelerator card, as the actual operation information of the target accelerator card. The task type may be: model inference tasks, model training tasks, batch data processing, and background data backup, etc.

Correspondingly, different task types may correspond to different priorities and resource allocation rules, specifically referring to a resource allocation table shown in Table 1. Therefore, in an implementation, the management device is configured to: query uncompleted task types in the task queue information and corresponding allocatable memory types thereof in a resource allocation table, to obtain at least one memory type.

TABLE 1

| | | Resource |
|---|---|---|
| Priority | Task type | allocation rules |
| 0 | Real-time | Exclusive DRAM |
| highest | inference tasks | resources to guarantee |
| | | minimum latency |
| 1 | Large model | On-demand allocation |
| | training tasks | of hybrid DRAM and |
| | | SSD resources |
| 2 | Batch data | SSD bandwidth |
| | processing | restricted |
| 3 | Background | Idle SSD resources |
| lowest | data backup | only |

If an accelerator card simultaneously runs tasks with different priorities, then the accelerator card may adopt a weighted fair queue algorithm to allocate bandwidth for tasks with different priorities in the target accelerator card. If the current available memory amount of the target accelerator card is lower than the memory amount required by the highest priority task when the highest priority task starts running, then the lowest priority task in the target accelerator card is suspended, and current state information of the lowest priority task is stored. If the management device discovers that one or more accelerator cards requesting memory at the same moment are running tasks with different priorities, then the management device may also adopt a weighted fair queue algorithm to allocate bandwidth for different accelerator cards for use in their memory requests. Furthermore, if the management device discovers that among all current memory devices, the memory amount available for use by the accelerator card where the high-priority task is located is small, then the memory request of the accelerator card where the low-priority task is located may be suspended, and the current state information of the memory request thereof is stored, so that when more memory is available, the memory request of the accelerator card where the low-priority task is located can proceed.

In an example, corresponding trigger conditions may be set for memory allocation of the accelerator card. For example: the management device is configured to: in a case where the memory occupation information exceeds a preset first threshold and a number of uncompleted tasks in the task queue information exceeds a preset second threshold, predict the memory demand amount for the target accelerator card. The prediction manner may be: using a trained prediction model with historical memory occupation information of the accelerator card, uncompleted task types in the task queue information, and the number of uncompleted tasks as data basis. Therefore, in an implementation, the management device is configured to: query the historical memory occupation information of the target accelerator card; predict the memory demand amount according to the historical memory occupation information, one or more types of uncompleted tasks in the task queue information, and a number of uncompleted tasks. The management device, for each accelerator card, may record the memory occupation information collected each time, thereby forming the historical memory occupation information of the accelerator card.

To facilitate management of each memory device, a memory record table may be set in the management device to record the memory type (DRAM resource type, SSD resource type, etc.), total memory capacity, used memory amount, remaining available memory amount of each memory device, and even which part of memory address of each of the memory devices is allocated to which accelerator card. This information may also be recorded therein. Therefore, in an implementation, the management device is configured to: query a remaining available memory amounts and one or more memory types of each memory device among the plurality of memory devices in a memory record table, to obtain a query result; determine the memory allocation result according to the query result, the memory demand amount, and the at least one memory type; determine, according to the memory allocation result, one or more identification information and one or more address segments of one or more memory devices among the plurality of memory devices allocated to the target accelerator card; and update the memory record table according to the one or more identification information and the one or more address segments.

Since the memory capacity of each memory device can be allocated for use by each accelerator card, it inevitably can also be released by each accelerator card, thus flexible utilization of extended memory can be achieved. In an implementation, the management device is configured to: in a case where the memory occupation information in the target accelerator card is lower than a preset third threshold, then reclaim a target size of memory resource from the target accelerator card, and update the memory record table and the routing table accordingly, specifically: delete a mapping relationship between the port of the target accelerator card and the port of the corresponding memory device recorded in the routing table, and change the used memory amount, remaining available memory amount, etc. of the corresponding memory device in the memory record table. The target size is an integer multiple of a set memory block size, where the set memory block size is a preset minimum memory size that can be requested for each time, such as setting to 4K, 1G, etc. Correspondingly, the target accelerator card is configured to: update the memory mapping table accordingly according to the memory resources of the target size, specifically: delete the mapping relationship between the port of the target accelerator card and the port of the corresponding memory device recorded in the memory mapping table.

In an implementation, the management device includes a management controller and a switching controller; the management controller is connected to the switching controller through a first protocol (such as PCIe) and a second protocol (such as I2C); the switching controller is connected to the plurality of accelerator cards and the plurality of memory devices through a third protocol (such as CXL); the management controller is connected to a host and the plurality of accelerator cards through a fourth protocol (such as PCIe). Peripheral Component Interconnect express (PCIe) is a high-speed serial computer expansion bus standard, used for connecting various peripherals and expansion cards inside a computer, capable of achieving high-bandwidth, low-latency data transmission. The management controller may perform related management operations on the switching controller, the plurality of accelerator cards, and the plurality of memory devices through Inter-Integrated Circuit Bus (I2C, a serial bus protocol configured to connect integrated circuits), and collect operation information of the plurality of accelerator cards and the plurality of memory devices through PCIe. The switching controller achieves memory read/write and memory allocation between the plurality of accelerator cards and the plurality of memory devices through Compute ExpressLink (CXL, an interconnect protocol for high-performance computing), improving efficiency. The management controller is connected to the host and the plurality of accelerator cards through PCIe, thus can construct a management network. The host dispatches various tasks to each accelerator card through the management network, achieving device management of the host for each accelerator card, etc. CXL is specifically a high-speed interface protocol, capable of achieving data exchange through low-latency, high-bandwidth connections, including three dynamic multiplexing sub-protocols: CXL.io, CXL.cache, and CXL.mem. CXL.io is similar to the IO protocol of PCIe. This protocol is enabled to perform operations such as discovery and enumeration, error reporting, and host physical address lookup. CXL.cache is a protocol for accessing caches, defining interactions between the processors and the devices, allowing connected CXL devices to use request and response methods to efficiently cache processor memory with extremely low latency. CXL.mem is a protocol for accessing memory, using load and store commands to provide the processors with access to device-attached storage, where the processor acts as a master device and the CXL device acts as a slave device, capable of supporting volatile and persistent memory architectures. Based on this, each accelerator card may perform read operations and/or write operations on memory devices connected to ports having a mapping relationship with the port of the target accelerator card through the management device.

It can be seen that in the present disclosure, each accelerator card among the plurality of accelerator cards is directly connected to the plurality of memory devices through the management device, and the management device collects the actual operation information of each accelerator card among the plurality of accelerator cards, so as to allocate memory space to each accelerator card on demand according to the actual operation information of the accelerator cards. That is: each memory device among the plurality of memory devices is not perceived by the host, the plurality of memory devices serve directly as extended memory for each accelerator card, thus it is unnecessary for the host to perform memory allocation for each accelerator card, thereby avoiding the situation of contention for resources such as bandwidth that is likely to occur when multiple accelerator cards simultaneously request memory, making data transmission latency less likely to occur, and achieving the purpose of expanding memory for the accelerator cards without affecting system operation performance.

A method for processing data provided by an embodiment of the present disclosure is introduced below. The data processing method described below may be referred to mutually with other embodiments described herein.

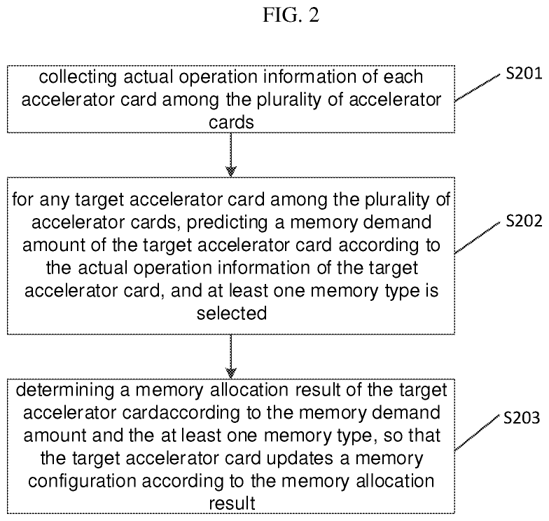

Referring to FIG. 2, embodiments of the present disclosure discloses a method for processing data, applied to a management device, where the management device is connected to a plurality of accelerator cards and a plurality of memory devices.

The method provided in this embodiment includes the following steps:

At S201, collecting actual operation information of each accelerator card among the plurality of accelerator cards.

At S202, for any target accelerator card among the plurality of accelerator cards, predicting a memory demand amount of the target accelerator card according to the actual operation information of the target accelerator card, and at least one memory type is selected; and

At S203, determining a memory allocation result of the target accelerator card according to the memory demand amount and the at least one memory type, so that the target accelerator card updates a memory configuration according to the memory allocation result.

In an implementation, the operation of collecting the actual operation information of each accelerator card includes: collecting memory occupation information, task queue information, and throughput in the target accelerator card, as the actual operation information of the target accelerator card.

In an implementation, in a case where the memory occupation information exceeds a preset first threshold and a number of uncompleted tasks in task queue information exceeds a preset second threshold, predicting the memory demand amount for the target accelerator card, then the following steps are executed: predicting the memory demand amount of the target accelerator card according to the actual operation information of the target accelerator card, and at least one memory type is selected; determining a memory allocation result of the target accelerator card according to the memory demand amount and the at least one memory type, so that the target accelerator card updates a memory configuration according to the memory allocation result.

In an implementation, the operation of predicting a memory demand amount of the target accelerator card according to the actual operation information of the target accelerator card includes: querying historical memory occupation information of the target accelerator card; and predicting the memory demand amount according to the historical memory occupation information, one or more types of uncompleted tasks in the task queue information, and a number of uncompleted tasks.

In an implementation, the operation of selecting at least one memory type includes: querying uncompleted task types in task queue one or more types of uncompleted tasks in the task queue information and at least one allocatable memory type corresponding to each of the one or more types of the uncompleted tasks in a preset resource allocation table, to obtain at least one memory type.

In an implementation, the operation of determining a memory allocation result of the target accelerator card according to the memory demand amount and the at least one memory type includes: querying a remaining available memory amount and one or more memory types of each memory device among the plurality of memory devices in a memory record table, to obtain a query result; determining the memory allocation result according to the query result, the memory demand amount, and the at least one memory type; determining, according to the memory allocation result, one or more identification information and one or more address segments of one or more memory devices among the plurality of memory devices allocated to the target accelerator card; and update the memory record table according to the one or more identification information and the one or more address segments.

In an implementation, the management device further determine, according to the memory allocation result, one or more identification information of one or more memory devices among the plurality of memory devices allocated to the target accelerator card; and record a mapping relationship between a port of each identification information of the one or more identification information and a port of the target accelerator card in a routing table, to update the routing table.

In an implementation, the operation of updating a memory configuration by the target accelerator card according to the memory allocation result includes: determining, according to the memory allocation result, one or more identification information and one or more address segments of the one or more memory devices among the plurality of memory devices allocated to the target accelerator card; and recording the one or more identification information and the one or more address segments in a preset memory mapping table, to update the memory mapping table.

In an implementation, in a case where the management device determines that memory occupation information in the target accelerator card is lower than a preset third threshold, reclaiming a target size of memory resources from the target accelerator card, and updating a memory record table and a routing table, wherein the target size is an integer multiple of a set memory block size; and the target accelerator card is configured to: update a memory mapping table according to the memory resources of the target size.

In an implementation, in the target accelerator card, in a case where a current available memory amount of the target accelerator card when a highest priority task starts running is lower than the memory amount required by the highest priority task, suspend a lowest priority task in the target accelerator card, and store current state information of the lowest priority task. The target accelerator card may further adopt a weighted fair queue algorithm to allocate bandwidth for tasks with different priorities in the target accelerator card. Read operations and/or write operations are performed on memory devices connected to ports having a mapping relationship with the port of the target accelerator card through the management device.

For more specific working process of each step in this embodiment, reference may be made to the corresponding content disclosed in the above embodiments, and no further description is given here.

It can be seen that this embodiment provides a method for processing data, wherein the plurality of accelerator cards are directly connected to the plurality of memory devices through the management device, and the management device collects the actual operation information of each accelerator card among the plurality of accelerator cards, so as to allocate memory space to each accelerator card on demand according to the actual operation information of the accelerator card. That is: each memory device is not perceived by the host, the plurality of memory devices serve directly as extended memory for each accelerator card, thus it is unnecessary for the host to perform memory allocation for each accelerator card, thereby avoiding the situation of contention for resources such as bandwidth that is likely to occur when multiple accelerator cards simultaneously request memory, making data transmission latency less likely to occur, and achieving the purpose of expanding memory for the accelerator cards without affecting system operation performance.

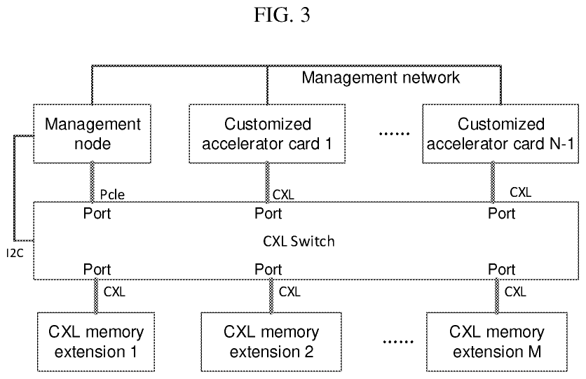

Please refer to FIG. 3. In a system for processing data, the management device includes a management node (i.e., management controller) and a switching controller CXL Switch. The management node connects to a port of the CXL Switch with the PCIe protocol, and other ports of the CXL Switch connect to a plurality of customized accelerator cards and a plurality of CXL memory extension devices. The management node further connects to the CXL Switch through I2C, so as to quickly implement management of the plurality of customized accelerator cards and the plurality of CXL memory extension devices with the I2C protocol, such as configuring memory devices. The management node and the plurality of customized accelerator cards construct a management network, which may connect to a host, so that the host implements task distribution and accelerator card management within this management network.

More specifically, a plurality of upstream ports of the CXL Switch are connected to N−1 paths of customized accelerator cards. The N−1 paths of customized accelerator cards integrate relevant logic for memory request and allocation internally, thus they are called the customized accelerator cards. The N−1 paths of customized accelerator cards logically constitute a computing subsystem. The plurality of downstream ports of the CXL Switch are connected to M paths of CXL memory extension devices, whose memory media are DRAM or SSD, supporting dynamic media type identification and hybrid addressing. The ratio of upstream and downstream ports may be flexibly deployed according to needs, with a typical configuration being 8 upstream (7 customized accelerator cards+1 management node) and 8 downstream CXL memory extension devices, supporting up to 16-path interconnection. Resource management control software Fabric Management (FM) in the management node is responsible for topology management, resource scheduling, and policy coordination of the entire system, and may run in a separate management node or be embedded in the CXL Switch controller.

The management node connects to the CXL Switch through a PCIe port, and the plurality of customized accelerator cards and the plurality of CXL memory extension devices connect to the CXL Switch through CXL ports. The management node and a BMC inside each CXL memory extension devices among the plurality of CXL memory extension devices jointly control and manage the CXL Switch to implement a CXL memory extension pool. The management node further monitors the local memory usage situation of each customized accelerator card among the plurality of customized accelerator cards, and triggers dynamic request, allocation and release of extended memory at appropriate times.

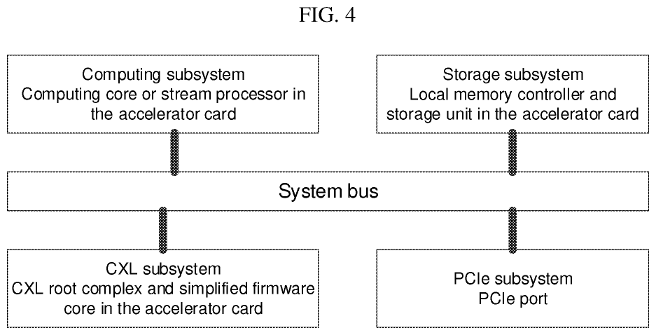

Referring to the system described in FIG. 3, correspondingly, the logical control system may be FIG. 4. Each customized accelerator card shown in FIG. 3 may constitute the computing subsystem in FIG. 4, each memory device and memory in the customized accelerator card shown in FIG. 3 may constitute the storage subsystem in FIG. 4, the management node, the CXL Switch, and relevant modules responsible for address management in the customized accelerator card (such as simplified firmware cores) shown in FIG. 3 may constitute the CXL subsystem in FIG. 4, and the PCIe ports shown in FIG. 3 constitute the PCIe subsystem in FIG. 4. The computing subsystem, CXL subsystem, PCIe subsystem, and storage subsystem are interconnected through a system bus.

The CXL subsystem includes a simplified firmware core and a CXL root complex.

The CXL root complex is a bridge connecting the computing subsystem and CXL devices (such as CXL switch, CXL memory extension devices), responsible for establishing and maintaining physical and logical connections between the management node and CXL devices, recording the memory address range of the root port of each CXL device, processing memory requests from the accelerator card, converting the memory requests into formats required by the CXL protocol, and forwarding the memory requests to corresponding CXL memory extension device. The function of the simplified firmware core is to support and enhance the functions of the root complex, enabling the system to manage memory and data transmission more efficiently, responsible for initializing storage devices connected to the root complex, responsible for initializing the Host Managed Device Memory (HDM) decoder in the accelerator card, and managing relevant physical memory address ranges to ensure the system can correctly access and use these memory resources. CXL endpoints are identified by checking configuration space of the endpoints and PCIe BAR addresses, and the memory address space of each of the endpoints is summarized by checking an HDM registry. The computing subsystem includes main computing cores or stream processors of the accelerator card, etc. The PCIe subsystem mainly includes PCIe ports, responsible for establishing communication with the management node or host. The storage subsystem further includes DDR controllers and DDR storage units in the accelerator card.

Referring to the illustrations of FIG. 3 and FIG. 4, the management node may dynamically allocate extended memory according to actual demands of the accelerator card, and the accelerator card may perform read and write operations on the extended memory. For example: when a local memory usage rate of accelerator card 1 exceeds a threshold, FM dynamically allocates 2 GB DRAM resources in the extended memory pool to the accelerator card through the CXL Switch, and the accelerator card directly accesses the memory through the CXL subsystem.

The management node connects to an upstream port of the CXL Switch, monitors the memory usage situation of each accelerator card in real time, and dynamically performs memory allocation through the FM. The following steps may specifically be included.

### S1: Collecting Data and Monitoring.

The management node collects the usage situation of local memory of each accelerator card through the management network, such as accelerator card 1 local memory occupation 95%, accelerator card 2 local memory occupation 60%, and task queue information, such as accelerator card 1 task queue loading a large batch of data.

### S2: Triggering Memory Extension Strategy.

An extension request is triggered at an appropriate time according to preset rules. Taking a preset threshold rule as an example, if the accelerator card local memory usage rate or the predicted accelerator card memory usage rate exceeds 90% and the task priority currently running in the accelerator card is high, then the extension request is triggered.

In some implementations, FM may adopt a memory allocation strategy based on load prediction, thereby triggering an extension strategy based on prediction results. The prediction model is pre-trained, configured to output future memory demand amounts. Data such as accelerator card historical memory usage rates (statistics by a certain time window), task type characteristics (model training, image inference, batch data processing, etc.), queue depth, and throughput (such as queuing instruction counts of processor cores, etc.) may be collected to train the prediction model. The model may select, for example, Long Short Term Memory (LSTM), random forest, etc. After the training is completed, the trained prediction model is utilized to predict future memory demands, and the extension strategy is triggered according to the prediction results.

In some implementations, FM may adopt a priority scheduling algorithm to balance resource contention problems among multiple accelerator cards. As shown in Table 1, memory resource allocation and priority division are performed according to task types currently running in different accelerator cards. Specifically, tasks with higher priorities reserve more bandwidth to guarantee low latency, tasks with lower priorities share remaining bandwidth, and specifically, algorithms such as weighted fair queue may be adopted for scheduling. A resource preemption strategy may further be set, for example, when the highest priority task is triggered, extended memory already allocated to lower-level tasks may be preempted, and intermediate states of the lower-level tasks are saved to SSD.

### S3: Allocating Address Space.

The FM of the management node checks the global memory pool status, selects an available area (locating to a specific available memory device according to records of the memory record table), generates an allocation instruction, and allocates the corresponding memory area to the corresponding accelerator card. The extension result may be sent to the simplified firmware core in the corresponding accelerator card through the management network.

### S4: Updating HDM Decoder.

The accelerator card modifies the HDM decoder therein through the simplified firmware core, extending its physical address range to cover the newly extended memory area. Specifically, configuration parameters of the HDM decoder may be modified so that it can identify and access the extended physical memory area, for example, modifying base addresses and sizes in the register definition file of the HDM decoder to adjust the upper limit of physical addresses supported by the decoder; updating the device memory mapping table, adjusting BARs in the PCIe configuration space, extending the address window of PCIe BARs, and mapping a larger range of memory to the accelerator card.

### S5: Synchronizing CXL Switch Routing Table.

The CXL Switch updates the port mapping relationship in the routing table, binding the downstream port connected to the corresponding memory device to the upstream port corresponding to accelerator card 1, ensuring correct routing of requests.

In an implementation, specific steps for memory release are as follows.

### S1: Collecting Data and Monitoring.

The management node collects the usage situation of local memory of each accelerator card and task queue information through the management network.

### S2: Triggering Memory Release Strategy.

A memory release request is triggered at an appropriate time according to preset rules. Taking a preset threshold rule as an example, if the local memory usage rate is lower than 50% and the task priority is low, then a release request is triggered.

### S3: Releasing Address Space.

The FM of the management node checks the global memory pool status, generates a release instruction to reclaim extended memory already allocated to the accelerator card, and sends the reclamation result to the simplified firmware core of the corresponding accelerator card through the management network.

### S4: Updating HDM Decoder.

The simplified firmware core of the accelerator card modifies the HDM decoder of the accelerator card, reducing its physical address range to remove addresses of the released extended memory area.

### S5: Synchronizing CXL Switch Routing Table.

The CXL Switch updates the port mapping relationship, unbinding the downstream port of the corresponding memory device from the upstream port corresponding to the accelerator card, releasing the routing relationship between the two.

In an implementation, the processing process for the accelerator card to read extended memory is as follows.

S1: Read request is initiated: the accelerator card computing unit generates a read operation.

S2: The storage subsystem determines that the read operation address is outside the DDR range and hands it over to the CXL subsystem for processing.

S3: The root complex parses the address, determines that the DDR range belongs to the mapping range of extended memory, converts the request into CXL protocol format, and adds target endpoints and transaction tags.

S4: The CXL Switch routes the read request to the extended memory connected to the corresponding downstream port according to the port mapping table.

S5: The memory extension executes the read operation and returns a data block from the target address.

S6: Response data is transmitted back to the root complex of the accelerator card through the CXL Switch, converted into the accelerator card local bus format, and then delivered to the accelerator card computing unit.

In an implementation, the processing process for the accelerator card to write extended memory is as follows.

S1: Write request is initiated: the accelerator card computing unit generates a write operation.

S2: The storage subsystem determines that the write operation address is outside the DDR range and hands it over to the CXL subsystem for processing.

S3: The root complex parses the address, determines that the DDR range belongs to the mapping range of extended memory, converts the request into CXL protocol format, and adds target endpoints and transaction tags.

S4: The CXL Switch routes the read request to the extended memory connected to the downstream port according to the port mapping table.

S5: The memory extension executes the write operation, writes data to the target address, and returns an acknowledgment signal.

S6: The acknowledgment signal is transmitted back to the root complex of the accelerator card through the CXL Switch, converted into the accelerator card local bus format, and then informs the accelerator card computing unit.

It can be seen that in this embodiment, a memory extension pool shared by multiple accelerator cards is constructed based on the CXL high-speed interconnect protocol, capable of achieving dynamic memory expansion of the accelerator cards, and improving the utilization rate of accelerator card computing resources in computing scenarios such as machine learning. This solution design can bypass host memory, achieving direct memory expansion of the accelerator cards, reducing data movement, and effectively reducing extended memory access latency. The management node can dynamically allocate extended memory resources based on real-time monitoring of accelerator card memory usage and subsequent task queues, effectively avoiding resource idleness and improving the overall resource utilization rate of the system.

In terms of architecture design, by integrating the CXL subsystem (containing a root complex and a simplified firmware core) with a single-layer CXL Switch topology design, a shared extended memory pool for multiple accelerator cards is constructed, achieving direct expansion bypassing host memory. The root complex is responsible for conversion and routing of local memory requests and CXL protocols, the simplified firmware core dynamically manages address spaces and HDM decoders, and combined with flexible port mapping of the Switch, the conventional PCIe bus contention problem is solved, improving the bandwidth utilization efficiency of extended memory.

A collaborative control mechanism for dynamic memory capacity management is provided in memory allocation. By monitoring the accelerator card memory usage status in real time through the management node to trigger memory extension or release processes, combined with dynamic adjustment of HDM decoders (extending or reducing physical address ranges) and synchronous updates of CXL Switch routing tables, on-demand allocation of pooled memory is achieved. Such mechanism ensures dynamic and elastic scheduling of extended memory resources among multiple accelerator cards through collaboration between firmware and hardware (such as FM global scheduling, address space binding and unbinding), avoiding waste of storage resources.

An electronic device provided by an embodiment of the present disclosure is introduced below. The electronic device described below may be referred to mutually with other embodiments described herein. The electronic device may be any device described in the above embodiments, such as a management device, an accelerator card, etc.

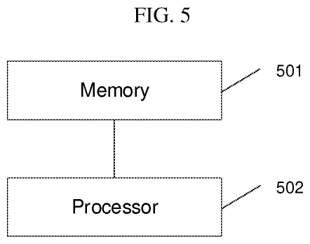

Referring to FIG. 5, embodiments of the present disclosure disclose an electronic device, including: a memory 501, configured to store a computer program; and a processor 502, configured to execute the computer program, so as to implement the method disclosed in any of the above embodiments.

In this embodiment, when the processor executes the computer program stored in the memory, the following steps may be specifically implemented: collecting actual operation information of each accelerator card among the plurality of accelerator cards; for any target accelerator card among a plurality of accelerator cards, predicting a memory demand amount of the target accelerator card according to the actual operation information of the target accelerator card, and selecting at least one memory type; determining a memory allocation result of the target accelerator card according to the memory demand amount and the at least one memory type, so that the target accelerator card updates a memory configuration according to the memory allocation result.

In this embodiment, when the processor executes the computer program stored in the memory, the following steps may be specifically implemented: collecting memory occupation information, task queue information, and throughput in the target accelerator card, as the actual operation information of the target accelerator card.

In this embodiment, when the processor executes the computer program stored in the memory, the following steps may be specifically implemented: in a case where the memory occupation information exceeds a preset first threshold and the number of uncompleted tasks in the task queue information exceeds a preset second threshold, predicting of the memory demand amount for the target accelerator card.

In this embodiment, when the processor executes the computer program stored in the memory, the following steps may be specifically implemented: querying historical memory occupation information of the target accelerator card; and predicting the memory demand amount according to the historical memory occupation information, one or more types of uncompleted tasks in the task queue information, and a number of uncompleted tasks.

In this embodiment, when the processor executes the computer program stored in the memory, the following steps may be specifically implemented: querying one or more types of uncompleted tasks in the task queue information and at least one allocatable memory type corresponding to each of the one or more types of the uncompleted tasks in a preset resource allocation table, to obtain at least one memory type.

In this embodiment, when the processor executes the computer program stored in the memory, the following steps may be specifically implemented: querying a remaining available memory amount and one or more memory types of each memory device among the plurality of memory devices in a memory record table, to obtain a query result; determining the memory allocation result according to the query result, the memory demand amount, and the at least one memory type; determining, according to the memory allocation result, one or more identification information and one or more address segments of one or more memory devices among the plurality of memory devices allocated to the target accelerator card; and updating the memory record table according to the one or more identification information and the one or more address segments.

In this embodiment, when the processor executes the computer program stored in the memory, the following steps may be specifically implemented: determining, according to the memory allocation result, one or more identification information of one or more memory devices among the plurality of memory devices allocated to the target accelerator card; and recording a mapping relationship between a port of each identification information of the one or more identification information and a port of the target accelerator card in a routing table.

In this embodiment, when the processor executes the computer program stored in the memory, the following steps may be specifically implemented: determining, according to the memory allocation result, one or more identification information and one or more address segments of the one or more memory devices among the plurality of memory devices allocated to the target accelerator card; and recording the one or more identification information and the one or more address segments in a memory mapping table.

In this embodiment, when the processor executes the computer program stored in the memory, the following steps may be specifically implemented: in a case where the memory occupation information in the target accelerator card is lower than a preset third threshold, reclaiming a target size of memory resources from the target accelerator card, and updating a memory record table and a routing table accordingly, wherein the target size is an integer multiple of a set memory block size.

In this embodiment, when the processor executes the computer program stored in the memory, the following steps may be specifically implemented: updating a memory mapping table according to the memory resources of the target size.

In this embodiment, when the processor executes the computer program stored in the memory, the following steps may be specifically implemented: iin a case where a current available memory amount of the target accelerator card when a highest priority task starts running is lower than the memory amount required by the highest priority task, suspending a lowest priority task in the target accelerator card, and storing current state information of the lowest priority task.

In this embodiment, when the processor executes the computer program stored in the memory, the following steps may be specifically implemented: adopting a weighted fair queue algorithm to allocate bandwidth for tasks with different priorities in the target accelerator card.

In this embodiment, when the processor executes the computer program stored in the memory, the following steps may be specifically implemented: performing read operations and/or write operations on memory devices connected to ports having a mapping relationship with the port of the target accelerator card through the management device.

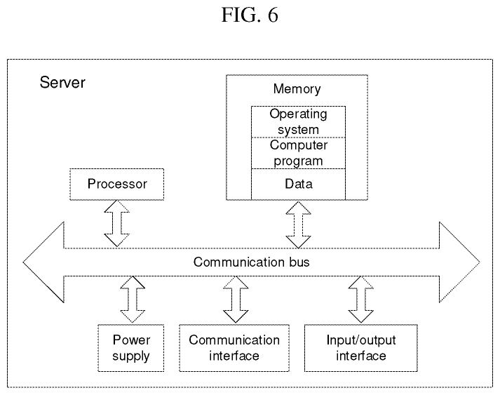

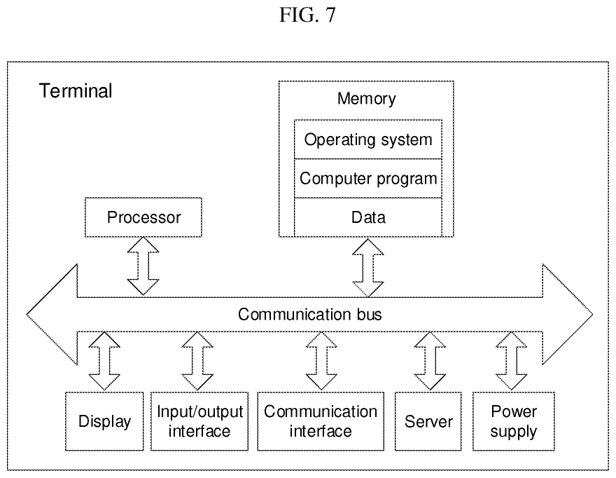

Furthermore, an embodiment of the present disclosure further provides an electronic device. The above electronic device may be either a server as shown in FIG. 6 or a terminal as shown in FIG. 7. Both FIG. 6 and FIG. 7 are structural diagrams of an electronic device shown according to an exemplary embodiment, and the content in the figures shall not be considered as any limitation on the using scope of the present disclosure.

FIG. 6 is a structural schematic diagram of a server provided by an embodiment of the present disclosure. The server may specifically include: at least one processor, at least one memory, a power supply, a communication interface, an input/output interface, and a communication bus. The memory is configured to store a computer program, and the computer program is loaded and executed by the processor, so as to implement relevant steps in the data processing disclosed in any of the above embodiments.

In this embodiment, the power supply is configured to provide operating voltage for each hardware device on the server; the communication interface is capable of creating a data transmission channel between the server and external devices, and the communication protocol it follows is any communication protocol applicable to the technical solution of the present disclosure, and no specific limitation is placed thereon; and the input/output interface is configured to acquire external input data or output data to the outside, and its specific interface type may be selected according to specific application needs, and no specific limitation is placed thereon.

Additionally, as a carrier for resource storage, the memory may be a Read-Only Memory (ROM), Random Access Memory (RAM), magnetic disk, or optical disk, etc., the resources stored thereon include an operating system, computer programs, data, etc., and the storage manner may be temporary storage or permanent storage.

The operating system is configured to manage and control each hardware device and computer program on the server, so as to achieve operation and processing of data in the memory by the processor, and it may be Windows Server, Netware, Unix, Linux, etc. In addition to including computer programs capable of completing the data processing method disclosed in any of the above embodiments, the computer program may further include computer programs capable of completing other specific tasks. In addition to including data such as update information of applications, the data may further include data such as developer information of applications.

FIG. 7 is a structural schematic diagram of a terminal provided by an embodiment of the present disclosure, and the terminal may specifically include but not be limited to smartphones, tablet computers, laptop computers, or desktop computers, etc.

The terminal in this embodiment usually includes: a processor and a memory.

The processor may include one or more processing cores, such as a 4-core processor, an 8-core processor, etc. The processor may be implemented using at least one hardware form of Digital Signal Processing (DSP), Field-Programmable Gate Array (FPGA), or Programmable Logic Array (PLA). The processor may further include a main processor and a coprocessor. The main processor is a processor used to process data in an awake state, also known as a Central Processing Unit (CPU); the coprocessor is a low-power processor used to process data in a standby state. In some embodiments, the processor may be integrated with a Graphics Processing Unit (GPU), and the GPU is configured to be responsible for rendering and drawing content required to be displayed on a display screen. In some embodiments, the processor may further include an Artificial Intelligence (AI) processor, and the AI processor is configured to process computational operations related to machine learning.

The memory may include one or more non-volatile storage media, and the computer non-volatile storage media may be non-transitory. The memory may further include high-speed random access memory, and non-volatile memory, such as one or more magnetic disk storage devices or flash memory storage devices. In this embodiment, the memory is at least configured to store the following computer program, where after the computer program is loaded and executed by the processor, relevant steps in the data processing method executed by the terminal side disclosed in any of the above embodiments can be implemented. In addition, resources stored in the memory may further include an operating system and data, etc., and the storage mode may be temporary storage or permanent storage. The operating system may include Windows, Unix, Linux, etc. The data may include but not be limited to update information of applications.

In some embodiments, the terminal may further include a display screen, an input/output interface, a communication interface, a sensor, a power supply, and a communication bus.

Those skilled in the art may understand that the structure shown in FIG. 7 does not constitute a limitation on the terminal, and may include more or fewer components than illustrated.

A non-volatile storage medium provided by an embodiment of the present disclosure is introduced below. The non-volatile storage medium described below may be referred to mutually with other embodiments described herein.

A non-volatile storage medium, configured to store a computer program, where the computer program, when executed by a processor, implements the method for processing data disclosed in the above embodiments The non-volatile storage medium is a computer-readable non-volatile storage medium, which, as a carrier for resource storage, may be an ROM, RAM, magnetic disk, or optical disk, etc., the resources stored thereon include an operating system, computer programs, data, etc., and the storage manner may be temporary storage or permanent storage.

A computer program product provided by an embodiment of the present disclosure is introduced below. The computer program product described below may be referred to mutually with other embodiments described herein.

A computer program product, including a computer program/instruction, where the computer program/instruction, when executed by a processor, implements the steps of the data processing method disclosed above.

The various embodiments in the specification are described in a progressive manner, with each of the embodiments focusing on differences from other embodiments. Identical or similar parts among the various embodiments can be referred to each other.

Steps of methods or algorithms described in conjunction with the embodiments disclosed herein may be implemented directly by hardware, software modules executed by a processor, or a combination of both. Software modules may be placed in RAM, memory, ROM, electrically programmable ROM, electrically erasable programmable ROM, registers, hard disks, removable disks, CD-ROM, or any other form of non-volatile storage medium known in the technical field.

Specific examples have been applied herein to illustrate the principles and implementations of the present disclosure. The descriptions of the above embodiments are merely used for helping understand the method and core idea of the present disclosure; meanwhile, for those of ordinary skill in the art, changes may be made in specific implementations and application scopes according to the idea of the present disclosure. In summary, the content of this specification should not be understood as a limitation on the present disclosure.

1. A system for processing data, comprising: a management device, a plurality of accelerator cards, and a plurality of memory devices, wherein each accelerator card among the plurality of accelerator cards is connected to the plurality of memory devices through the management device;
the management device is configured to: collect actual operation information of each accelerator card among the plurality of accelerator cards;
the management device is further configured to: for any target accelerator card among the plurality of accelerator cards, predict a memory demand amount of the target accelerator card according to the actual operation information of the target accelerator card, select at least one memory type, and determine a memory allocation result of the target accelerator card according to the memory demand amount and the at least one memory type; and
the target accelerator card is configured to: update a memory configuration according to the memory allocation result;
the management device comprises a management controller and a switching controller; the management controller is connected to the switching controller through a first protocol and a second protocol; the switching controller is connected to the plurality of accelerator cards and the plurality of memory devices through a third protocol; and the management controller is connected to a host and the plurality of accelerator cards through a fourth protocol;
each memory device among the plurality of memory devices is not perceived by the host, the plurality of memory devices serve directly as extended memory for each accelerator card, it is unnecessary for the host to perform memory allocation for each accelerator card.

2. The system for processing data according to claim 1, wherein the management device is configured to:
collect memory occupation information, task queue information, and throughput in the target accelerator card, as the actual operation information of the target accelerator card.

3. The system for processing data according to claim 2, wherein the management device is configured to:
in a case where the memory occupation information exceeds a preset first threshold and a number of uncompleted tasks in the task queue information exceeds a preset second threshold, predict the memory demand amount for the target accelerator card.

4. The system for processing data according to claim 2, wherein the management device is configured to:
query historical memory occupation information of the target accelerator card; and
predict the memory demand amount according to the historical memory occupation information, one or more types of uncompleted tasks in the task queue information, and a number of uncompleted tasks.

5. The system for processing data according to claim 2, wherein the management device is configured to: query one or more types of uncompleted tasks in the task queue information and at least one allocatable memory type corresponding to each of the one or more types of the uncompleted tasks in a preset resource allocation table, to obtain the at least one memory type.

6. The system for processing data according to claim 1, wherein the management device is configured to:
query a remaining available memory amount and one or more memory types of each memory device among the plurality of memory devices in a memory record table, to obtain a query result;
determine the memory allocation result according to the query result, the memory demand amount, and the at least one memory type;
determine, according to the memory allocation result, one or more identification information and one or more address segments of one or more memory devices among the plurality of memory devices allocated to the target accelerator card; and
update the memory record table according to the one or more identification information and the one or more address segments.

7. The system for processing data according to claim 1, wherein the management device is configured to:
determine, according to the memory allocation result, one or more identification information of one or more memory devices among the plurality of memory devices allocated to the target accelerator card; and
record a mapping relationship between a port of each identification information of the one or more identification information and a port of the target accelerator card in a routing table.

8. The system for processing data according to claim 1, wherein the target accelerator card is configured to:
determine, according to the memory allocation result, one or more identification information and one or more address segments of the one or more memory devices among the plurality of memory devices allocated to the target accelerator card; and
record the one or more identification information and the one or more address segments in a memory mapping table.

9. The system for processing data according to claim 1, wherein the management device is configured to:
in a case where memory occupation information in the target accelerator card is lower than a preset third threshold, reclaim a target size of memory resources from the target accelerator card, and update a memory record table and a routing table, wherein the target size is an integer multiple of a set memory block size; and
the target accelerator card is configured to: update a memory mapping table according to the memory resources of the target size.

10. The system for processing data according to claim 1, wherein the target accelerator card is configured to:
in a case where a current available memory amount of the target accelerator card when a highest priority task starts running is lower than the memory amount required by the highest priority task, suspend a lowest priority task in the target accelerator card, and store current state information of the lowest priority task.

11. A method for processing data, applied to a management device, wherein the management device is connected to a plurality of accelerator cards and a plurality of memory devices, comprising:
collecting actual operation information of each accelerator card among the plurality of accelerator cards;
for any target accelerator card among the plurality of accelerator cards, predicting a memory demand amount of the target accelerator card according to the actual operation information of the target accelerator card, and selecting at least one memory type; and
determining a memory allocation result of the target accelerator card according to the memory demand amount and the at least one memory type, so that the target accelerator card updates a memory configuration according to the memory allocation result;
the management device comprises a management controller and a switching controller; the management controller is connected to the switching controller through a first protocol and a second protocol; the switching controller is connected to the plurality of accelerator cards and the plurality of memory devices through a third protocol; and the management controller is connected to a host and the plurality of accelerator cards through a fourth protocol;
each memory device among the plurality of memory devices is not perceived by the host, the plurality of memory devices serve directly as extended memory for each accelerator card, it is unnecessary for the host to perform memory allocation for each accelerator card.

12. An electronic device, comprising:
a memory, configured to store a computer program; and
a processor, configured to execute the computer program, so as to implement the method as claimed in claim 11.

13. A non-volatile storage medium, configured to store a computer program, wherein the computer program, when executed by a processor, implements the method as claimed in claim 11.

14. A computer program product, comprising a computer program/instructions, wherein the computer program/instruction, when executed by a processor, implements the method as claimed in claim 11.
